(19) United States
(12) Patent Application Publication
(10) Pub. No.: US 2009/0274311 A1
(43) Pub. Date: Nov. 5, 2009

(54) Multi-Channel Audio Load Box With Selectable Loading

(75) Inventors: Joo Teik Siew, Georgetown (MY); Kwang Jin Gooi, Georgetown (MY); Wai Beng Lam, Georgetown (MY)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(73) Assignee: AGILENT TECHNOLOGIES, INC., Loveland, CO (US)

(21) Appl. No.: 12/111,970

(22) Filed: Apr. 30, 2008

(51) Int. Cl. H04R 29/00

(52) U.S. Cl. 381/58

(57) ABSTRACT

An audio load box to test multiple audio channels using selectable loading for each channel. A resistive load is switched into the signal path of each audio channel before audio tests are conducted. The resistive load can be a single resistor or resistors in parallel. The multi-channel audio load box with selectable loading can provide greater flexibility, reliability and accuracy for tests, for example inter-channel phase measurements and crosstalk.

### BACKGROUND OF THE INVENTION

An audio load box provides a fixed load configuration for an audio channel during audio functional testing. The audio load box can accommodate multiple audio channels in one audio box fixture. Devices Under Test (DUTs) have their audio channel outputs terminated in a fixed load impedance to maximize power transfer or to match specified measurement conditions.

An example of such a measurement condition is when a power amplifier is tested to deliver an output voltage at the current drawn by a the loudspeaker. In this instance, the loudspeaker is replaced by a load, i.e. resistor of a fixed resistance, either 2, 4 or 8Ω.

Alternatively, the DUT to be tested may be a receiver for a home theater, an audio power amplifier or a DVD player, or one of hundreds of other devices that require audio testing.

Current in-car infotainment systems provide more than just audio entertainment, they add information and services useful to drivers for safety, communications and navigation. Sophisticated infotainment systems are equipped with the latest digital audio and video services, GPS and communication systems such as Bluetooth and WLAN.

Increasing integration of audio and information systems built into vehicles has led to a demand in sophisticated audio testing systems.

An audio channel can comprise two wires. A signal path of the audio channel is the path a signal takes from one wire through a load and returns through the second wire. Alternatively, the second wire can be a ground wire.

Presently on the production floor or in the R&D lab, an audio load box, comprising multiple channels with non-selectable or non-variable resistive loads, provides limited freedom to test an audio system during production or research. As described above, a load in a multiple channel audio box is fitted with a fixed resistive load value. In some instances, the resistive load can be manually reconfigured by physically removing the resistive load and replacing it with another value, making the audio load box a quasi-selectable load box.

Inter-channel phase measurements and crosstalk are audio engineering tests that are measured in relationship to a reference waveform. The reference can be a signal at a different point in the system, or a related signal in a different channel in the system. It is possible that the reference channel or the channel under test has a different loading resistance value.

When performing inter-channel phase and crosstalk tests, the quasi-selectable load box described above can create inefficiencies. It can lead to improper test conditions and inconsistent results, and consequently creates a scenario where reproducing results can be a daunting task.

Unfortunately, present audio load box offerings do not cater to the testing requirements of contemporary audio testing systems. A void in the industry is a multiple channel audio box with a selectable or variable load for each audio channel.

Audio testing facilities desire an audio load box design that can be customized. This can comprise testing additional channels and with a higher power rating for the load and selecting load values for each channel.

Accordingly, a need exists to test an audio system comprising multiple audio channels using selectable loading for each audio channel.

### BRIEF DESCRIPTION OF THE DRAWINGS

FIG. 1 is a block diagram describing a multi-channel audio load box with selectable loading within an audio testing system;

FIGS. 2A-B are schematic drawings of the audio load box with selectable loading; and

FIG. 3 is a flow chart describing the operation of the audio load box with selectable loading in an audio test.

### DETAILED DESCRIPTION

The description herewith details a multiple audio channel load box with selectable or variable load settings for each audio channel. A multi-channel audio load box with selectable loading (“selectable load box”) enables an audio test engineer to conveniently and efficiently test a multi-channel audio system with a variety of load settings. The selectable load box can improve repeatability and speed of testing in an R&D laboratory or on a production line. The selectable load box can also aid in conducting tests requiring simultaneous channels with different loads.

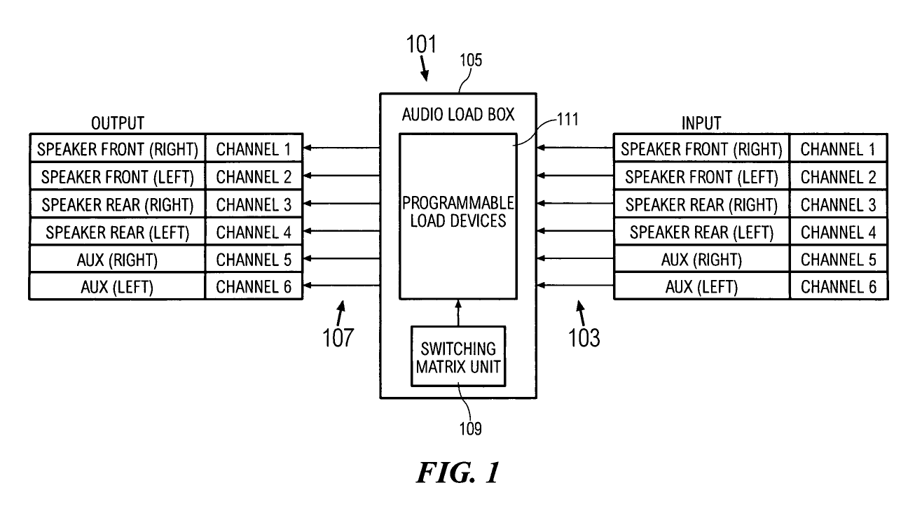

FIG. 1 is a block diagram describing a selectable load box 105 within an audio testing system 101.

Input ports 103 comprising six audio channels are fed into the selectable load box 105. Output ports 107 comprising six audio channels are also illustrated in FIG. 1. The output ports 107 can be connected to an audio analyzer (not shown).

Selectable (or programmable) load devices 111 in the selectable load box 105 are used to simulate an actual speaker load. For example, high power load settings can be resistors of value 2, 4 and 8 Ohms with a power rating of 40 Watts. Meanwhile, the low power load settings can be 100K, 47K and 10K Ohms with a power rating of 2 Watts.

The selectable load box 105 comprises a switching matrix unit 109. The switching matrix unit 109 provides a switching platform. The switching platform actuates a load device from within the selectable load devices 111 to simulate a load for an audio channel.

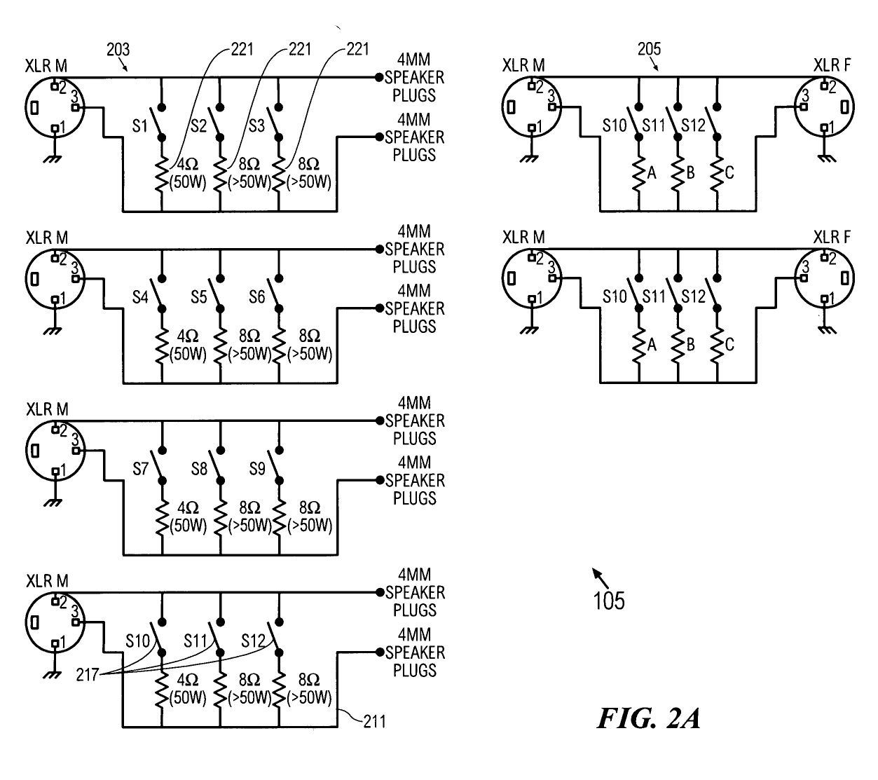

FIG. 2A is a schematic drawing of the selectable load box 105. The schematic illustrates 6 audio channels with 3 load settings apiece. The six audio channels comprise four channels 203 of selectable load devices with fixed load values and two channels 205 of selectable load devices with variable load values. The variable load devices can be load devices that are removable (and replaceable) or can be load devices with an adjustable resistance value setting. For example, the resistors for the variable load devices can be a combination of fixed value resistors which are, 100K ohm (+/−5%), 47K ohm (+/−5%) and 10 ohm (+/−5%).

The four audio channels 203 have 4 mm speaker plugs and XLR connectors as input and output ports respectively. The three load devices are connected by individual switches. For example switches S10, S11 and S12 217 connect the two wires of audio channel 211. Examples of switches are mechanical relays, electronic relays and reed switches. The switches 217 can be part of the switching matrix unit 109.

In audio channels 203 the load resistors 221 are configured with 4, 8 and 8 Ohms of varying wattage. In audio channels 205, the load resistors are configured with variable resistor values to provide design flexibility to an operator. The operator can add values of resistance or wattage for specific application as required.

The switches in each audio channel, for example the switches S10, S11 and S12 217 of audio channel 211 can be applied individually or in a parallel combination to achieve a desired load and power rating. For example, parallel combinations of the resistor loading of the audio channel 211 can produce resistor values with a larger power rating. The switches can be controlled manually or through the switching matrix unit 109 as part of a larger test system.

FIG. 2B is a schematic diagram illustrating a design of an audio channel 251 using a single switch 253. The audio channel 251 is one of many audio channels in the audio box 105. When the switch 253 is actuated, a load device is inserted between the audio channel wires. The switch 253 can be controlled manually or through the switching matrix unit 109 as part of a larger test system.

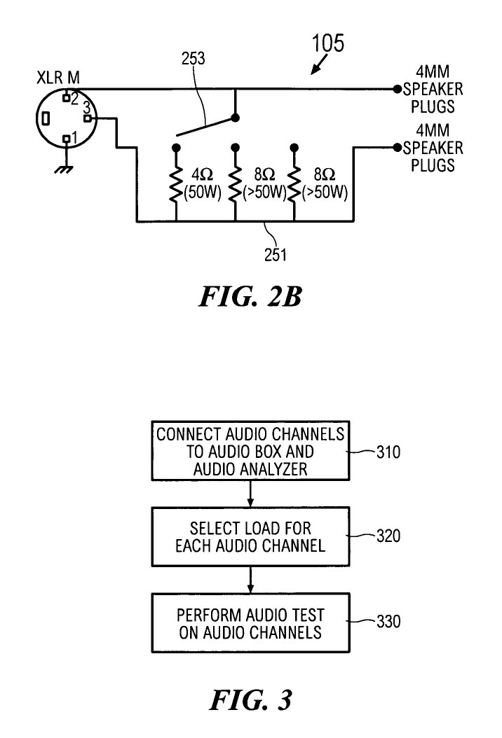

FIG. 3 is a flow chart describing the operation of the selectable load box 105 during an audio test. Block 310 describes connecting audio channels to the input 103 and output 107 ports of the selectable load box 105. Block 320 describes selecting a load resistance value for each audio channel. This is achieved by making a selection through the switching matrix unit 109. The selection can comprise more than one load device if permissible, creating a parallel combination from the individual load values. Block 330 describes performing the audio tests on the audio channels.

While the embodiments described above constitute exemplary embodiments of the invention, it should be recognized that the invention can be varied in numerous ways without departing from the scope thereof. It should be understood that the invention is only defined by the following claims.

1. An audio load box for testing audio channels, comprising:
a first input port of the audio load box for receiving a signal from a first audio channel;
a second input port of the audio load box for receiving a signal from a second audio channel;
a first load electrically connected to the first input port for receiving the signal from the first audio channel;
a second load electrically connected to the second input port for receiving the signal from the second audio channel;
a first switch electrically connected to the first input port, the first switch for adjusting the value of the first load; and
a second switch electrically connected to the second input port, the second switch for adjusting the value of the second load.

2. The audio load box of claim 1, wherein the first load and the second load comprise at least two resistors each.

3. The audio load box of claim 1, further comprising an additional switch electrically connected to the first input port, the additional switch also for adjusting the value of the first load.

4. The audio load box of claim 3, wherein both the first switch and the additional switch adjust the value of the first load.

5. The audio load box of claim 1, further comprising an additional switch electrically connected to the second input port, the additional switch also for adjusting the value of the second load.

6. The audio load box of claim 5, wherein both the second switch and the additional switch adjust the value of the second load.

7. The audio load box of claim 1, wherein the first switch and the second switch are within a switching matrix unit.

8. The audio load box of claim 1, wherein the first load or the second load or both the first and the second loads comprise variable resistors.

9. The audio load box of claim 1, wherein the first load or the second load or both the first and the second loads comprise removable and replaceable resistors.

10. The audio load box of claim 1, wherein the audio channels are connected to the audio load box from outputs of a power amplifier system and the audio channels are tested by an audio analyzer.

11. A method of testing a multi-channel audio system, comprising the steps of:
connecting a first audio channel to a first input port of an audio load box, the first input port electrically connected to a first switch;
adjusting a value of a first load using the first switch, the first switch electrically connecting the first load to the first input port;
connecting a second audio channel to a second input port of the audio load box, the second input port electrically connected to a second switch; and
adjusting a value of a second load using the second switch, the second switch electrically connecting the second load to the second input port.

12. The method of claim 11, wherein the first load and the second load comprise at least two resistors each.

13. The method of claim 11, further comprises the step of performing audio tests on the first or second audio channels or both the first and second audio channels.

14. The method of claim 11, further comprises the step of adjusting the value of the first load using an additional switch, the additional switch being electrically connected to the first input port and the additional switch electrically connecting the first load to the first input port.

15. The method of claim 14, wherein both the first switch and the additional switch operable to adjust the value of the first load.

16. The method of claim 11, further comprises the step of adjusting the value of the second load using an additional switch, the additional switch being electrically connected to the second input port and the additional switch electrically connecting the second load to the second input port.

17. The method of claim 16, wherein the second switch or the additional switch or both the second switch and the additional switch operable to adjust the value of the second load.

18. The method of claim 11, wherein the first and second switches are within a switching matrix unit.

19. The method of claim 11, wherein the first load or the second load or both the first and the second loads comprise variable resistors.

20. The method of claim 11, wherein the first load or the second load or both the first and the second loads comprise removable and replaceable resistors.
